(19) United States
(12) Patent Application Publication
(10) Pub. No.: US 2016/0273623 A1
(43) Pub. Date: Sep. 22, 2016

(54) TENSIONER WITH CLOSED-CELL FOAM BIASING MEMBER

(71) Applicant: LITENS AUTOMOTIVE PARTNERSHIP, Woodbridge (CA)

(72) Inventor: Gary J. Spicer, Mississauga (CA)

(21) Appl. No.: 15/072,054

(22) Filed: Mar. 16, 2016

Related U.S. Application Data
(60) Provisional application No. 62/133,643, filed on Mar. 16, 2015.

(51) Int. Cl. F16H 7/12; F16H 7/08

(52) U.S. Cl. CPC F16H 7/129; F16H 7/08; F16H 2007/0819; F16H 2007/0865; F16H 2007/0893; F16H 2007/0872; F16H 2007/0891

(57) ABSTRACT

In one embodiment, there is provided a tensioner for an endless drive member. The tensioner comprises a base that is mountable to a stationary structure, the base defining a tensioner arm pivot axis, a tensioner arm that is mounted to the base and is pivotable about the tensioner arm pivot axis, a pulley rotatably connected to the tensioner arm for rotation about a pulley axis that is spaced from the tensioner arm pivot axis, and a tensioner arm biasing member positioned to urge the tensioner arm in a free arm direction. The tensioner arm biasing member includes a closed-cell foam member.

### CROSS-REFERENCE TO RELATED APPLICATIONS

This application claims the benefit of U.S. Provisional Patent Application No. 62/133,643 filed Mar. 16, 2015, the contents of which are incorporated herein in their entirety.

### FIELD

This disclosure relates generally to the art of belt tensioners and more particularly to belt tensioners for automotive front engine accessory drive systems.

### BACKGROUND

Tensioners are devices that may be used to maintain tension in an endless drive member such as a belt, that is driven by en engine and that is used to drive accessories such as one or more of an alternator, a water pump, an air conditioning compressor, a power steering pump and/or other devices.

Situations arise where the belt undergoes rapid increases and decreases in tension as a result of engine torsionals and other events. Torsionals are torsional vibrations that can occur with any internal combustion engine, and particularly with certain engines such as those with a low cylinder count (e.g. four cylinders or less), diesel engines, or other engines. Such torsionals can affect the tensioner by causing rapid oscillations of the tensioner arm, which generally have negative impact on the longevity of the tensioner and can in some instances result in the tensioner pulley being thrown off the belt temporarily. It is generally desirable to dampen these motions of the tensioner arm, particularly in the direction away from the belt.

While tensioners have implemented springs such as helical compression springs or torsion springs to impart the desired biasing force upon the endless drive member, such springs are largely ineffective in providing a damping force. As a result, additional damping elements have been introduced into tensioners of the prior art in an effort to reduce the effect of torsionals on the tensioner. Such tensioners, however, are complex and costly to manufacture, sensitive to the entry of contaminants, and can be subject to a change in their operating characteristics due to wear in the damping elements. It would be desirable to provide a tensioner that at least partially addresses one or more of these issues.

### SUMMARY

In one embodiment, there is provided a tensioner for an endless drive member. The tensioner comprises a base that is mountable to a stationary structure, the base defining a tensioner arm pivot axis, a tensioner arm that is mounted to the base and is pivotable about the tensioner arm pivot axis, a pulley rotatably connected to the tensioner arm for rotation about a pulley axis that is spaced from the tensioner arm pivot axis, and a tensioner arm biasing member positioned to urge the tensioner arm in a free arm direction. The tensioner arm biasing member includes a closed-cell foam member.

In another embodiment, there is provided a tensioner for an endless drive member. The tensioner comprises a base that is mountable to a stationary structure, a tensioning guide that is positioned to engage the endless drive member, and a tensioner biasing member positioned to urge the tensioning guide into the endless drive member. The tensioner biasing member includes a closed-cell foam member.

### BRIEF DESCRIPTION OF THE DRAWINGS

The foregoing and other features and advantages will be apparent from the following description of the disclosure as illustrated in the accompanying drawings. The accompanying drawings, which are incorporated herein and form a part of the specification, further serve to explain the principles of the disclosure and to enable a person skilled in the pertinent art to make and use the disclosure. The drawings are not to scale.

FIG. 1 is a partial cross-sectional view of a tensioner incorporating a tensioner arm biasing member according to a first embodiment hereof.

FIG. 2 is a partial cross-sectional view of a tensioner arm biasing member according to a second embodiment hereof.

FIG. 3 is a partial cross-sectional view of a tensioner arm biasing member according to a third embodiment hereof.

FIG. 4 is a partial cross-sectional view of a tensioner arm biasing member according to a forth embodiment hereof.

FIG. 5 is a partial cross-sectional view of a tensioner arm biasing member according to a fifth embodiment hereof.

FIG. 6 is a partial cross-sectional view of a tensioner arm biasing member according to a sixth embodiment hereof.

FIG. 7 is a plan view of a tensioner incorporating a tensioner arm biasing member according to a seventh embodiment hereof.

FIG. 8 is a plan view of the tensioner of FIG. 7 shown in a deflected state.

FIG. 9 is a plan view of a tensioner incorporating a tensioner arm biasing member according to an eighth embodiment hereof.

FIG. 10 is a plan view of the tensioner of FIG. 9 shown in a deflected state.

FIG. 11 is a plan view of a tensioner incorporating a tensioner arm biasing member according to a ninth embodiment hereof.

FIG. 12 is a plan view of the tensioner of FIG. 11 shown in a deflected state.

FIG. 13 is a plan view of a tensioner incorporating a tensioner arm biasing member according to a tenth embodiment hereof.

FIG. 14 is a plan view of the tensioner of FIG. 13 shown in a deflected state.

FIG. 15 is a schematic view of a tensioner arranged for use in tensioning a timing drive.

FIGS. 16 and 17 show the use of a CCF member in a Lovejoy™-type coupling.

FIG. 18 shows the use of a CCF member in a tensioner arm biasing member which excludes a sealing structure.

FIG. 19 shows the tensioner arm biasing member of FIG. 18 in a partial compressed state.

FIG. 20 shows the tensioner arm biasing member of FIG. 18 in a fully compressed state.

FIGS. 21-23 show several force/displacement curves for different types of flexure of a CCF member.

### DETAILED DESCRIPTION

Specific embodiments of the present disclosure are now described with reference to the figures, wherein like reference numbers indicate identical or functionally similar elements. The following detailed description is merely exemplary in nature and is not intended to limit the disclosure or the application and uses of the disclosure. Furthermore, there is no intention to be bound by any expressed or implied theory presented in the preceding technical field, background, brief summary or the following detailed description.

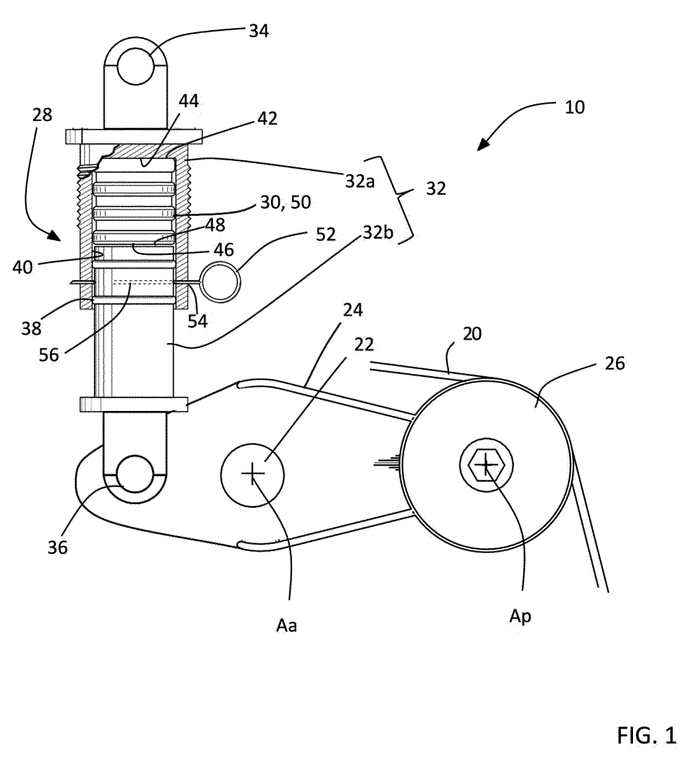

Reference is made to FIG. 1, which shows a tensioner 10 for maintaining tension in a belt 20 or other endless drive member. The belt may be part of an endless drive system such as a Front End Accessory Drive (FEAD) system on a vehicular engine. The tensioner 10 includes a base 22 that is mountable to a stationary structure (e.g. the frame and other structural elements of the vehicle, such as the engine block), a tensioner arm 24 that is, in some embodiments, pivotally mounted to the base 22 for pivoting movement about a tensioner arm pivot axis Aa, and a pulley 26 that is rotatably mounted to the tensioner arm 24, for rotation about a pulley axis Ap that is spaced from the pivot axis Aa. The tensioner 10 also includes a tensioner arm biasing member 28 that is positioned to urge the tensioner arm 24 in a free arm direction, that is in a direction along the path that the tensioner arm 24 is capable of reaching upon being urged by the tensioner arm biasing member 28 (counterclockwise in the view shown in FIG. 1). For greater clarity, the stationary structure is the entirety of all suitable structural portions of the vehicle (or of the tensioner's environment in the case of a non-vehicular application) that is considered stationary for the purposes of mounting portions of the tensioner 10. In a vehicular application, this would correspond to the frame of the vehicle, the engine block and support frame, the vehicle body and any non-moving structural elements and components. It will be appreciated that while a belt is described, any suitable other endless drive member may be used. In addition, while a pulley (e.g. pulley 26) is described, any other suitable rotary drive member may be used.

The tensioner arm biasing member 28 includes a resilient element 30 contained within a biasing member support 32. The biasing member support 32 includes a first end member 32a and a second end member 32b. The first end member 32a is pivotally mounted to the stationary member at a stationary member pivot connector 34 that may be an aperture that receives a suitable fastener (e.g. a shoulder bolt). The second end member 32b is pivotally mounted to the tensioner arm 24 at a tensioner arm pivot connector 36 which may be an aperture that aligns with an aperture on the tensioner arm 24 so that both apertures receive a pin or rivet therethrough.

The second end member 32b moves linearly relative to the first end member 32a. To facilitate linear travel, the second end member 32b may be provided with at least one circumferential guide element 38 that engages a first end member inside surface 40 of the first end member 32a. In the embodiment shown, two circumferential guide elements are provided.

The resilient element 30 is positioned between the first end member 32a and the second end member 32b in a manner that resilient member 30 is positioned to urge the first and second end members 32a, 32b away from each other, and wherein upon movement of the second end member 32b towards the first end member 32a, the resilient element 30 is compressed therebetween. As shown in FIG. 1, the resilient element 30 has a first resilient element end 42 which engages the first end member 32a at a first compression surface 44, and a second resilient element end 46 which engages the second end member 32b at a second compression surface 48. On movement of the second end member 32b towards the first end member 32a, the distance between the first compression surface 44 and the second compression surface 48 decreases, thereby subjecting the resilient element 30 contained therein to compression.

The resilient element 30 is provided in the form of a closed-cell foam (CCF) member 50 having a corrugated outer surface. Accordingly, along the length of the CCF member 50, the corrugations introduce variations in the cross-sectional area of the CCF member 50 which varies the effective spring rate along its length. This permits the spring rate of the CCF member 50 to be tailored, for example to change as the CCF member 50 is compressed. Accordingly, the response of the CCF member 50 may be customized in a way that is not easily achieved with traditional torsion or helical compression springs. In addition, as compression can be more effectively directed to select regions of the CCF member 50, the deformation under compression can be more easily predicted and controlled. For example, the ability to direct initial compression of the CCF member 50 to regions of reduced cross-sectional area reduces the likelihood of regions of the CCF member 50, in particular regions of increased cross-sectional area from bulging and impacting upon the inside surface 40 of the first end member 32a. As friction between the CCF member 50 and the inside surface 40 of the first end member 32a is reduced, a more predictable load response is achieved, in addition to reduced wear.

The closed-cell foam member 50 is advantageous in that it can be lighter than a helical compression spring or a torsion spring as is used in some tensioners of the prior art. Furthermore, the CCF member 50 can, in some instances, compress to about 20 percent of its rest length, which permits a greater range of arm movement using a relatively small length for the tensioner arm biasing member 28. Another advantage to CCF springs is that variable spring rates may be achieved (e.g. by co-molding portions of the CCF member, each having different properties). Properties that may be varied in the different portions include: density of the CCF, the cell size and the outer diameter and inner diameter of the CCF spring (in embodiments wherein they are generally cylindrical).

Additionally the CCF member 50 can be tuned to provide a selected amount of energy dissipation. The CCF member 50, in at least some instances, has an inherent damping property that is the result of energy lost during collapse and expansion of the cells that make up the member 50. With a conventional elastic material exhibiting near ideal spring behaviour (i.e. a helical compression spring), deformation under load and the subsequent return to neutral upon removal of the load occurs without significant loss in energy, therein not providing a significant damping effect. With the CCF member 50, a portion of the energy is absorbed during deformation of the closed-cell foam material, and is dissipated, generally as heat. Advantageously, this behaviour of CCF materials and their usage in the tensioner arm biasing member 28 eliminates the need for a separate, friction-based, damping member, for reducing belt flutter and other related problems.

Continuing with the embodiment shown in FIG. 1, an installation pin 52 is provided that locks the first and second end members 32a and 32b in a selected position that in turn locks the tensioner arm 24 in a selected arm position which facilitates installation of the belt 20 in the belt drive system. This locking arrangement generally includes a first Installation pin pas-through aperture 54 in the first end member 32a and a second installation pin pass-through aperture 56 in the second end member 32b. Upon alignment of the first and second installation pin pass-through apertures 54, 56, the installation pin 52 can be inserted to lock the first and second end members 32a, 32b relative to one another. The location of the first and second installation pin pass-through apertures 54, 56 is selected to position the tensioner arm in such a way that belt installation is facilitated. In general, this position will have the resilient member 30 under compressive load, so that the belt 20 can more easily be pulled over it either when the belt 20 is installed on an engine that already has the tensioner 10 on it, or when the tensioner 10 is installed on an engine that already has the belt 20 on it.

Once the belt 20 has been installed, the installation pin 52 may be removed so that the tensioner arm biasing member 28 can extend and contract as needed, while driving the pulley 26 into the belt 20.

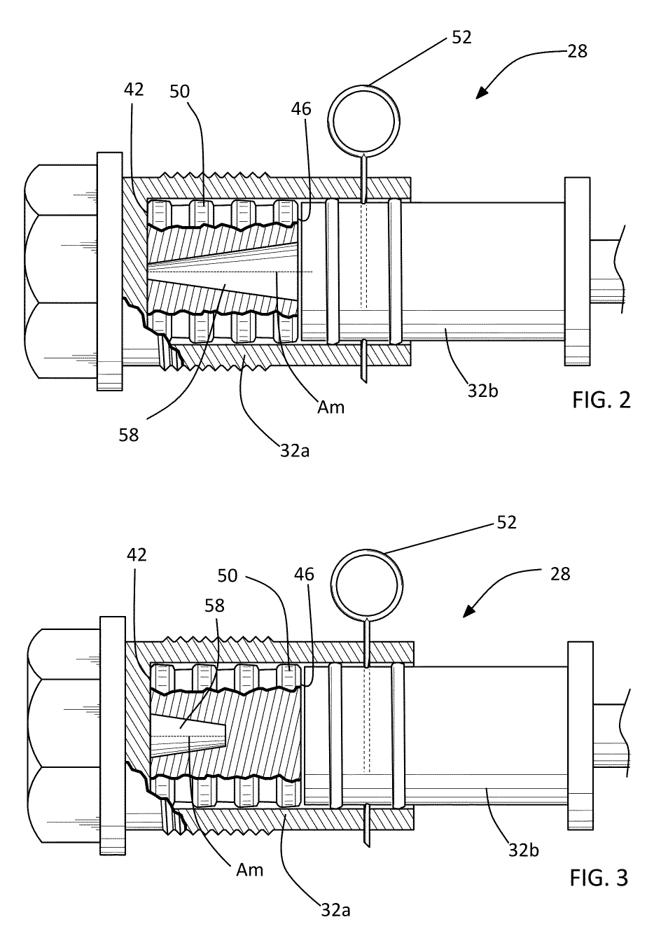

Referring now to FIGS. 2, 3 and 4, shown are three alternative embodiments wherein the CCF member is provided with internal apertures. The installation pin 52 is shown in each of FIGS. 2, 3 and 4, and it will be understood that the pin 52 is to be removed prior to use of the tensioner arm biasing member 28 in the tensioner 10.

Referring first to FIG. 2, the CCF member 50 is shown as having an internal aperture 58 positioned co-axially to a longitudinal axis Am of the CCF member 50, and extending along the length thereof. The internal aperture 58 is generally conical in shape and arranged to present an increasing cross-sectional area in the direction from the second resilient member end 46 to the first resilient member end 42. Accordingly, under load, compression of the CCF member 50 will initiate at the second resilient member end 46 and progressively propagate towards the first resilient member end 42 with a concurrent non-linear increase in observed spring rate that extends over the full range of compression of the CCF member 50.

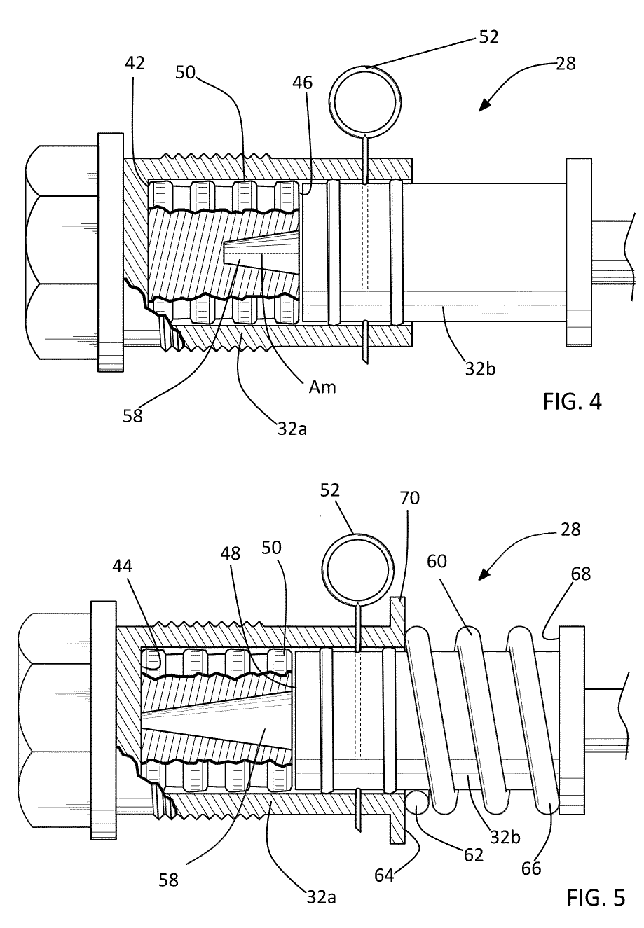

Having regard to FIG. 3, the CCF member 50 is shown as having an internal aperture 58 positioned co-axially to a longitudinal axis Am of the CCF member 50 and extending along a portion of the length thereof. The internal aperture 58 is generally conical in shape and arranged to present an increasing cross-sectional area in the direction from the first resilient member end 42 towards the second resilient member end 46. The arrangement shown in FIG. 4 is similar, with the exception that the internal aperture 58 is arranged to present an increasing cross-sectional area in the direction from the second resilient member end 46 towards the first resilient member end 42. Regardless of the orientation of the internal aperture 58, the compression of the CCF member 50 will initiate where the cross-sectional area is smaller, and progress towards the opposing end, with a concurrent increase in observed spring rate. With the embodiments of FIGS. 3 and 4, however, the spring rate will change most during the initial stages of compression of the CCF member 50.

In some embodiments, an additional biasing member may be incorporated into the tensioner arm biasing member 28. Having regard to FIG. 5, shown is a tensioner arm biasing member 28 constructed substantially as described with respect to FIG. 2. In FIG. 5, as in FIGS. 2, 3 and 4, the installation pin 52 is shown and would require removal prior to use of the biasing member 28. For brevity of explanation, only modifications or additions to the tensioner arm biasing member 28 shown in FIG. 5 relative to the embodiments in FIGS. 2, 3 and 4 are described. As shown in FIG. 5, the CCF member 50 is a first resilient member and the tensioner arm biasing member 28 includes a second resilient member, such as a helical compression spring 60 positioned in surrounding relationship to the second end member 32b, to impart an additional biasing force to the tensioner arm 24 (as shown in FIG. 1) in the free arm direction. The helical compression spring 60 has a first spring end 62 which engages the first end member 32a at a third compression surface 64, and a second spring end 66 which engages the second end member 32b at forth compression surface 68. To ensure proper seating of the first spring end 62 relative to the first end member 32a, the first end member 32a may be provided with a radial flange element 70. With this arrangement, on movement of the second end member 32b towards the first end member 32a, the distance between the first and second compression surfaces 44, 48 as well as the distance between the third and forth compression surfaces 64, 68 decrease, thereby subjecting the CCF member 50, and the compression spring 60 to compressive forces between respective compression surfaces. During use, the CCF member 50 and the compression spring 60 operate in series during compression between the first and second end members 32a, 32b.

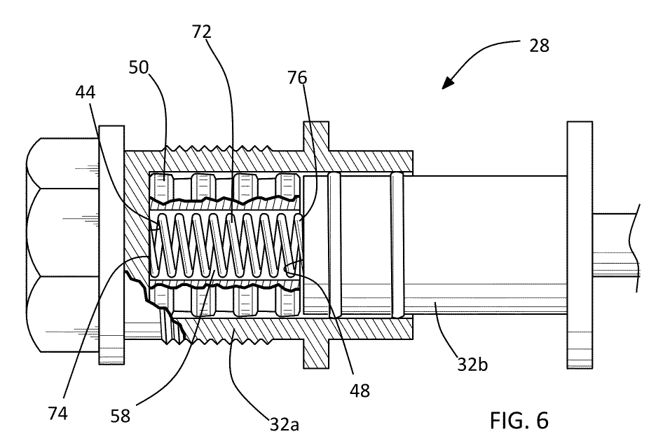

FIG. 6 presents an alternative embodiment of the tensioner arm biasing member 28 where an additional biasing member is provided, but where the additional biasing member is positioned within a cylindrical-shaped internal aperture 58 of the CCF member 50. Once again for brevity of explanation, only modifications or additions to the tensioner arm biasing member 28 are described. As shown, the CCF member 50 is a first resilient member, and the tensioner arm biasing member 28 includes a second resilient member which may be a helical compression spring 72, to impart an additional biasing force to the tensioner arm 24 (as shown in FIG. 1) in the free arm direction. The helical compression spring 72 is positioned in the internal aperture 58, and has a first helical compression spring end 74 which engages the first end member 32a at the first compression surface 44, and a second helical compression spring end 76 which engages the second end member 32b at the second compression surface 48. With this arrangement, on movement of the second end member 32b towards the first end member 32a, the distance between the first and second compression surfaces 44, 48 has the effect of subjecting both the CCF member 50, and the helical compression spring 72 to compressive forces between the first and second compression surfaces. During use, the CCF member 50 and the helical compression spring 72 operate in parallel during compression between the first and second end members 32a, 32b.

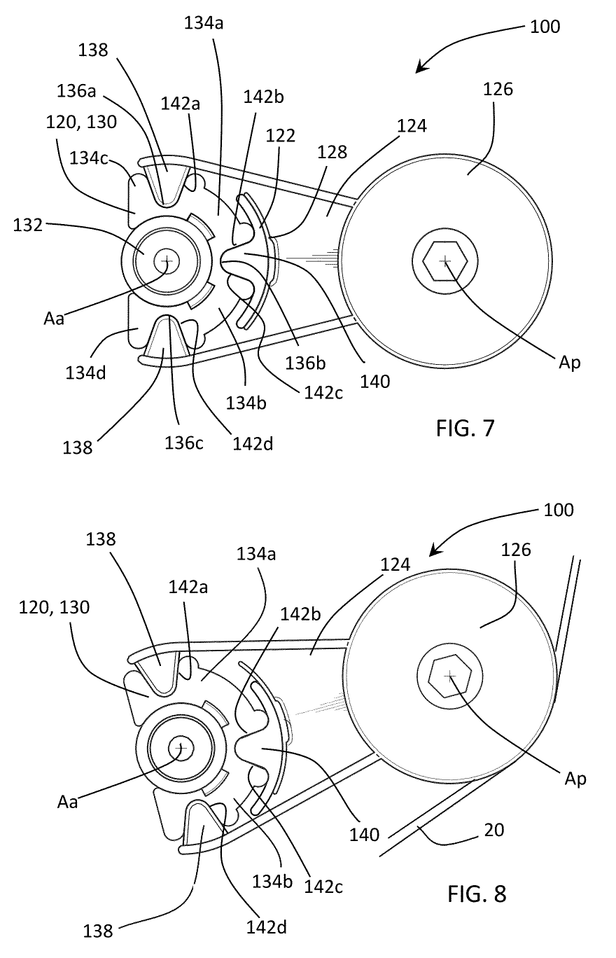

Referring now to FIGS. 7 and 8, shown is an alternative embodiment where tensioner 100 presents a generally lobed CCF member. The tensioner 100 includes a base 122 that is mountable to a stationary structure (e.g. the frame and other structural elements of the vehicle, such as the engine block), a tensioner arm 124 that is, in some embodiments, pivotally mounted to the base 122 for pivoting movement about a tensioner arm pivot axis Aa, and a pulley 126 that is rotatably mounted to the tensioner arm 124, for rotation about a pulley axis Ap that is spaced from the pivot axis Aa. The tensioner 100 also includes a tensioner arm biasing member 120 that is mounted to the base 122. A portion of the base 122 extends through a tensioner arm installation pin pass-through aperture 128 and is therein arranged to engage a portion of the tensioner arm biasing member 120.

As shown, the tensioner arm biasing member 120 is provided in the form of a lobed CCF member 130 mounted to the base 122 by anchor plate 132. The CCF member 130 presented in this embodiment has four lobes 134 (first lobe 134a, second lobe 134b, third lobe 134c, forth lobe 134d) and three recesses 136 (first recess 136a, second recess 136b, third recess 136c). The tensioner arm 124 has two diametrically opposed arm projections 138, and the base 122 (only a portion of which is shown in FIGS. 7 and 8) has one base projection 140. The lobed CCF member 130 is positioned angularly between the arm and base projections 138, 140. Accordingly, the two arm projections 138 of the tensioner arm 124 engage the first and third recesses 136a, 136c, while the one base projection 140 of the base 122 engages second recess 136b. With movement in the tensioner arm 124 relative to the base 122, the arm projections 138 will move relative to the stationary base projection 140. In the neutral state shown in FIG. 7, the lobe first 134a may be in compression between a first projection surface 142a and a second projection surfaces 142b, while the second lobe 134b may be in compression between a third projection surface 142c and a forth projection surface 142d. In the deflected state shown in FIG. 8, the distance between the third and forth projection surfaces 142c and 142d decreases relative to the distance in the neutral state, causing an increase in compression on the second lobe 134b situated therebetween. At the same time, the distance between the first and second projection surfaces 142a and 142b increases relative to the distance in the neutral state, causing a decrease in compression on the first lobe 134a situated therebetween. Both first and second lobes 134a, 134b remain in some state of compression however and contribute to the urging of the arm 124 into the belt 20.

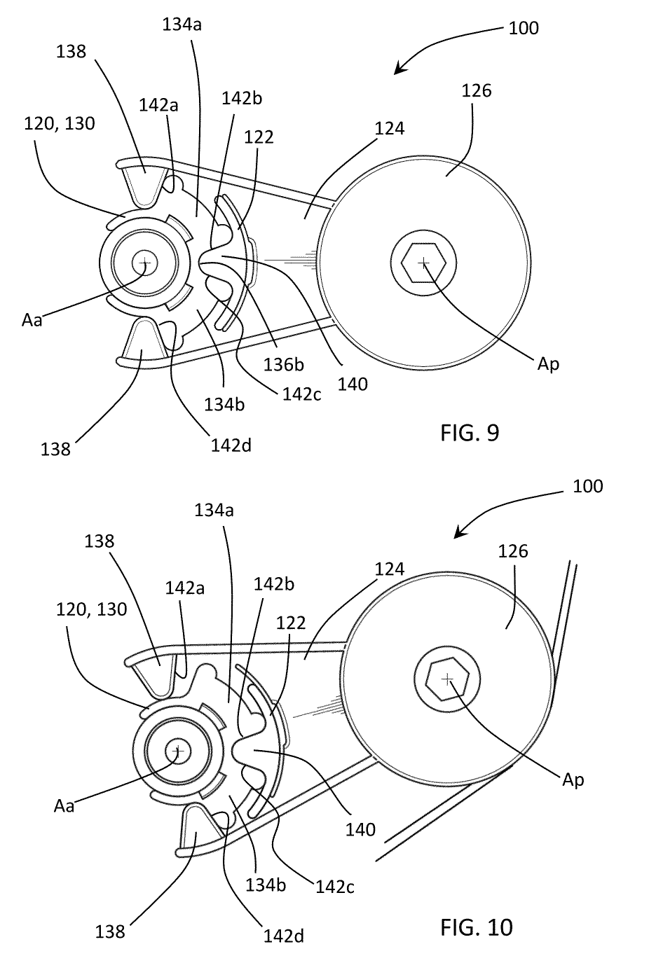

FIGS. 9 and 10 show an embodiment similar to that shown in FIGS. 7 and 8, with the exception that the CCF member 130 has only two lobes 134 (first lobe 134a, second lobe 134b). For brevity of explanation, only modifications or additions to the tensioner arm biasing member 120 are described. Accordingly, the arm projections 138 on the tensioner arm 124 engage the CCF member 120 on only one side, that is on the first projection surface 142a for the first lobe 134a, and on the forth projection surface 142d for the second lobe 134b. In this example, the first and second lobes 134a, 134b are not in compression when the tensioner arm 124 is in the neutral position (FIG. 9). Having regard to the deflected state shown in FIG. 10, the second lobe 134b is compressed between the third and forth projection surfaces 142c, 142d, while the first lobe 134a is uncompressed as evidenced by the separation between the first projection surface 142a and the first lobe 134a.

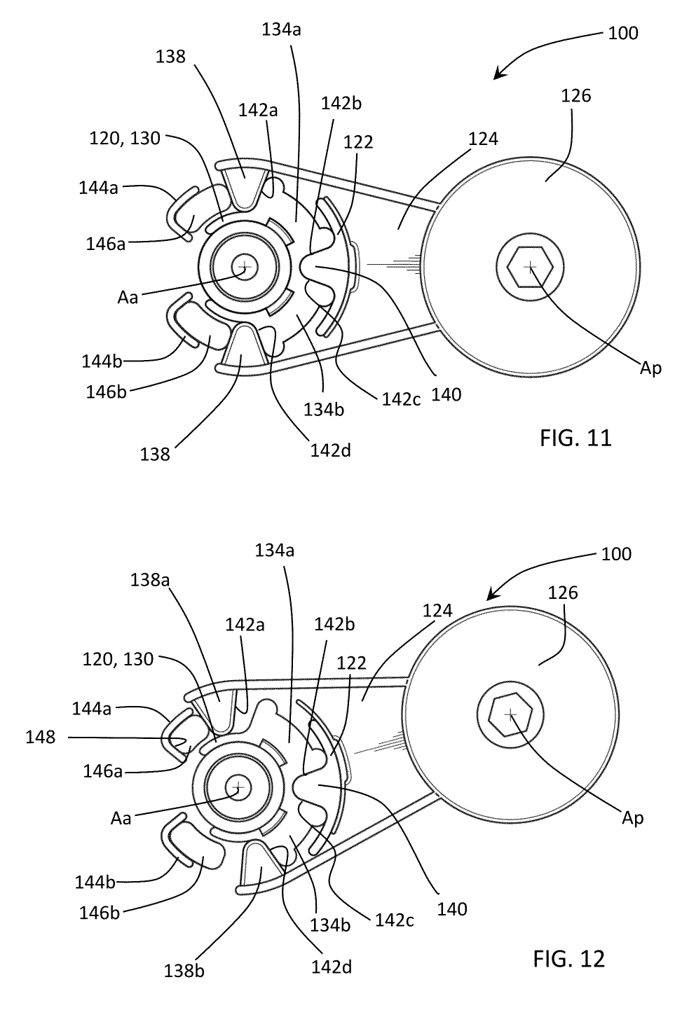

FIGS. 11 and 12 are similar to the embodiment shown in FIGS. 9 and 10, with the exception that there are two additional stationary engagement surfaces 144 (first engagement surface 144a, second engagement surface 144b) on the base 122 which are positioned to cooperate with the arm projections 138 on the tensioner arm 124 to compress one of two secondary CCF members 146 (first secondary CCF member 146a, second secondary CCF member 146b). For sake of brevity, only modifications or additions to the tensioner arm biasing member 120 are described. In this example, the first and second lobes 134a, 134b are not in compression when the tensioner arm 124 is in the neutral position (FIG. 11). Having regard to the deflected state shown in FIG. 12, the second lobe 134b is compressed between the third and forth projection surfaces 142c, 142d, while the first secondary CCF member 146a is compressed between the engagement surface 148 and the first arm projection 138a. At the same time, the first lobe 134a is uncompressed as evidenced by the separation between the first projection surface 142a and the first lobe 134a, and the second secondary CCF member 146b is uncompressed as evidenced by the separation between the second secondary CCF member 146b and the second arm projection 138b.

It will be appreciated that the tensioner arm 124 in FIGS. 9 and 11 is shown to be symmetric even though only the second lobe 134b and in the case of FIG. 11 the first secondary CCF member 146a is compressed during its operation. This permits the arm 124 to be used in any orientation without a need for a redesign of the tensioner 100. Alternatively the lobe 134 and the uncompressed second secondary CCF member 146b may simply be omitted in embodiments where they are not needed.

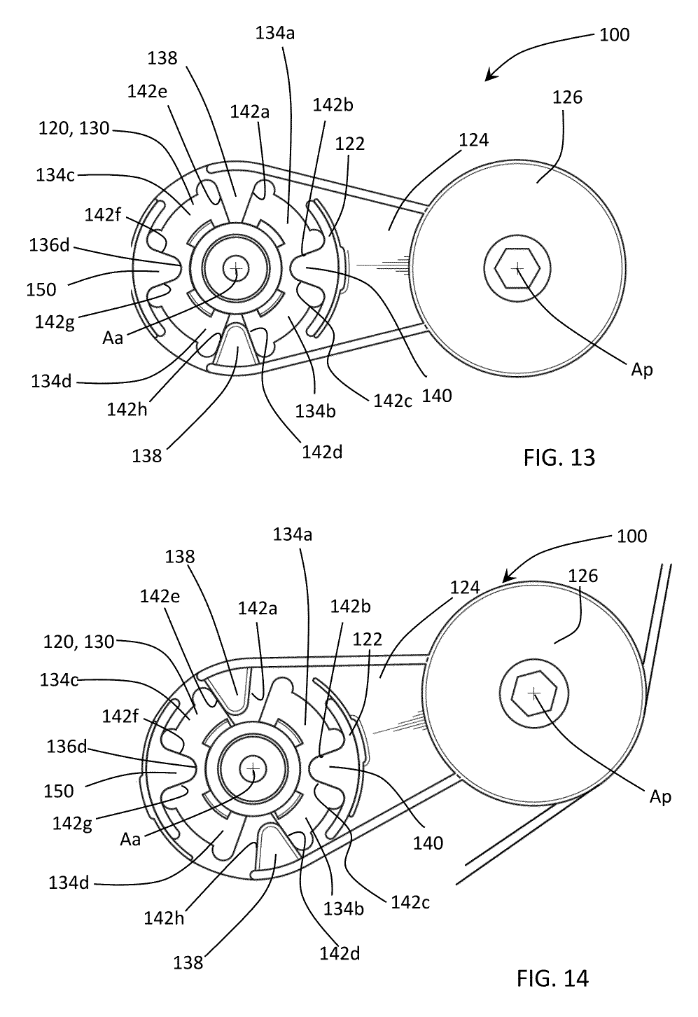

FIGS. 13 and 14 show an embodiment similar to the embodiment in FIGS. 9 and 10 except that the CCF member 130 has four symmetrical lobes 134 (first lobe 134a, second lobe 134b, third lobe 134c and forth lobe 134d, which are not in compression when the arm 124 is in the neutral position (FIG. 13). For sake of brevity, only modifications or additions to the tensioner arm biasing member 120 are described. The base 122 has a second stationary base projection 150 diametrically opposing the first base projection 140, the second base projection 150 being configured to engage a fourth recess 136d in the CCF member 130. In the neutral state shown in FIG. 13, the first lobe 134a is situated between the first and second projection surfaces 142a, 142b, the second lobe 134b is situated between the third and forth projection surfaces 142c, 142d, the third lobe 134c is situated between the fifth and sixth projection surfaces 142e, 142f, and the forth lobe 134d is situated between the seventh and eighth projection surfaces 142g, 142h. In the deflected state shown in FIG. 13, the distance between the third and forth projection surfaces 142c, 142d decreases relative to the distance in the neutral state, causing an increase in compression on the second lobe 134b situated therebetween. Similarly, the distance between the fifth and sixth projection surfaces 142e, 142f decreases relative to the distance in the neutral state, causing an increase in compression on the third lobe 134c situated therebetween. At the same time, the distance between the first and second projection surfaces 142a, 142b, and the seventh and eighth projection surfaces 142g, 142h increases relative to the distance in the neutral state, resulting in a separation between the first and eighth projection surfaces 142a, 142h and the respective first and forth lobes 134a, 134d.

It will be appreciated that while the first and second arm projections 138 and the first and second base projections 140, 150 are shown and detailed above as being diametrically opposed, this arrangement is merely exemplary for purposes of explanation. The positional relationship between the first and second arm projections 138, as well as the positional relationship between the first and second base projections 140, 150 may be angularly offset from 180°.

FIG. 15 shows an embodiment of a tensioner 200 configured for tensioning an endless drive member 210 in a timing drive. In this example, a crankshaft 220 is shown driving the endless drive member 210, which in turn drives a pair of camshafts 222. The endless drive member 210 may be, for example, a timing chain or any other suitable type of endless drive member that is synchronous with the rotary drive members shown at 224 driving the camshafts 220.

The tensioner 200 includes a base 226 that is mountable fixedly to a stationary structure shown at 228, a tensioner biasing member 230 which includes a CCF member 232, an endless drive member engagement member 234, which may be, for example, a tensioning guide in embodiments wherein the endless drive member 210 is a chain, and a connector 236 that pivotally connects the tensioner biasing member 230 at a pivotal connection 238 to the guide 234. The CCF member 232 urges the guide 234 into the chain 210 to maintain tension in the chain 210. The guide 234 is shown as being connected only to the tensioner 200 however in some embodiments, the guide 234 may be pivotally connected to a stationary structure 228. In such instances, the base 226 may be pivotally connected to the stationary structure 228. Any of the biasing structures shown in FIGS. 1-7 (which would include the biasing member 50, the end members 32a and 32b, and optionally the compression spring 60, and optionally the installation pin 52) could be used for the tensioner 200 shown in FIG. 15.

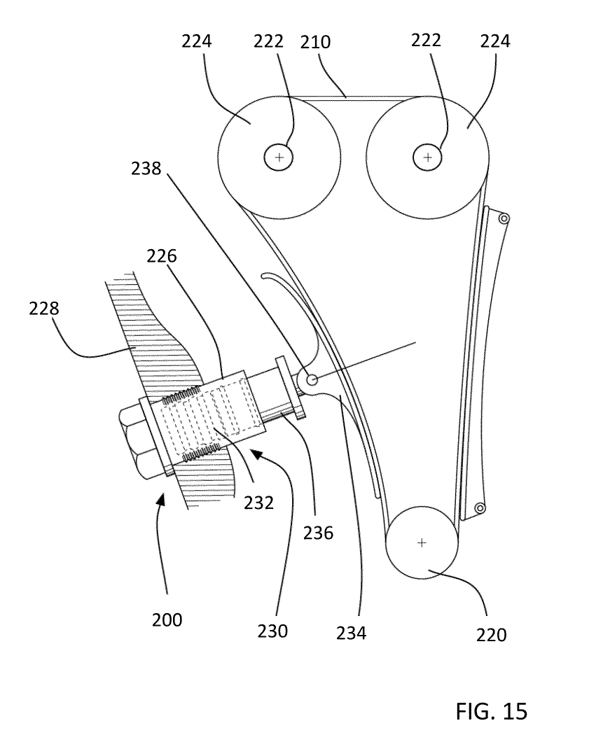

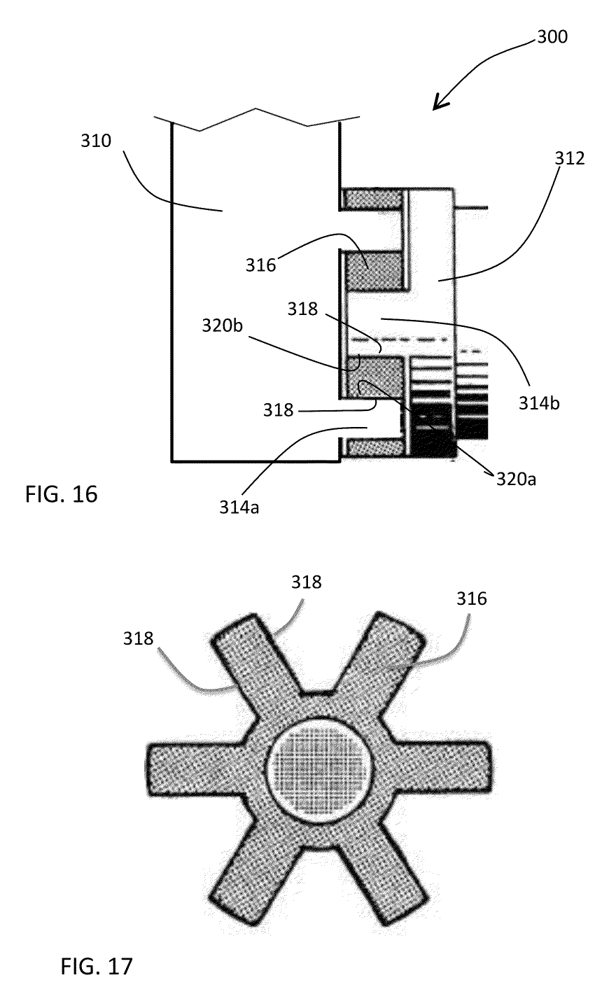

It will be appreciated that the closed-cell foam material used to construct the CCF members detailed above may find application in a style of coupling between the tensioner arm and the base that is similar to a Lovejoy™ coupling. Having regard to FIGS. 16 and 17, shown is a coupling 300 where the tensioner arm 310 and the base 312 each have axially extending projections 314a, 314b that are arranged to permit insertion of a spider-like CCF member 316. The CCF member 316 is shaped to present contact surfaces 318 that engage opposing projection surfaces 320a, 320b from each of the tensioner arm 310 and the base 312.

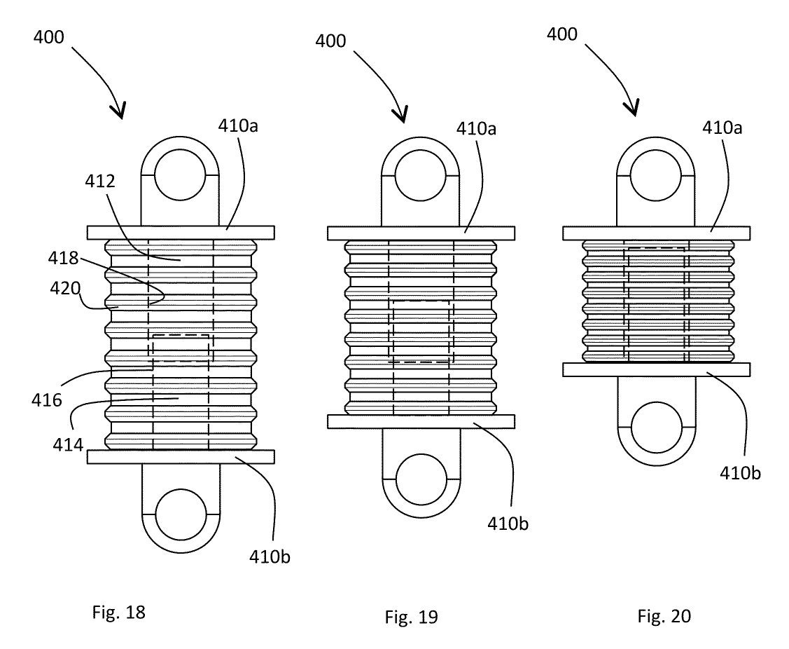

It will be noted that a closed-cell foam material can be selected for good abrasion resistance. It can also provide for weight reduction and simplification of the tensioner through, among other things, the elimination of the typical steel spring member used in typical tensioners, the elimination of the typical, Nylon-bushing-based damping structure in some tensioners, and the elimination of the typical sealing structure for inhibiting the migration of contaminants and moisture into a typical tensioner. The sealing structure in typical tensioners in some instances can be provided by using complex aluminum castings. Using a CCF member does not require a sealing structure and thus can be provided in at least some embodiments using shallow plates, or discs, thereby providing a cost savings in some applications. Reference is now made to FIG. 18 in which a tensioner arm biasing member 400 is shown which excludes a sealing structure. As presented, tensioner arm biasing member 400 includes a first end member 410a and a second end member 410b where the first and second end members 410a, 410b incorporate into a tensioner similar to that detailed in FIG. 1. The second end member 410b moves linearly relative to the first end member 410a. Relative movement is guided by a first end member guide 412 and a second end member guide 414 where the second end member guide 414 has an outside surface 416 that engages and slides relative to an inside surface 418 of the first end member guide 412. A CCF member 420 is positioned between the first end member 410a and the second end member 410b in a manner that movement of the second end member 410b towards the first end member 410a has the effect of compressing the CCF member 420 therebetween. Reference is made to FIG. 19 in which the tensioner arm biasing member 400 is shown in a partially compressed state, and well as FIG. 20 in which the tensioner arm biasing member 400 is shown in a fully compressed state. A particular advantage in using CCF for the resilient member is that upon compression, there is minimal outward deformation, that is the overall diameter of the CCF member 420 remains generally constant, as shown in FIGS. 18 through 20.

It will be noted that a tensioner according to the disclosure herein can have an increased take up rate compared to tensioners of the prior art.

In some instances it may be beneficial to maintain the temperature of the tensioner at or below a selected temperature, for example, in instances where it benefits the longevity of the closed-cell foam material. In such instances, the tensioner may be particularly suited to a belt-in-oil environment in which the tensioner is exposed to oil that is at a selected temperature to assist in controlling the temperature of the closed-cell foam.

The closed-cell foam material used in the tensioners shown and described herein may be any suitable material, including but not limited to TPU (Thermal Poly-Urethane). A specific example of a material that may be used for the CCF member is Cellasto™ sold by BASF™.

The performance of a closed-cell foam member may be superior to that of a typical compression spring in that a closed-cell foam member can in at least some embodiments collapse to about 20 percent of its original length (i.e. 20 percent of its uncompressed length), while maintaining substantially constant spring and damping characteristics (e.g. a constant spring force) throughout its range of compression and without significant lateral expansion. In some embodiments, the amount of lateral expansion that takes place between a free arm position for the tensioner arm and a load stop position for the tensioner arm may be less than 40 percent. As a result, stresses that may build up about its periphery may be small as compared, for example to a comparable rubber member that is, generally speaking, compressible by a much smaller amount relative to its uncompressed length, and that expands laterally by a larger amount from a smaller amount of compression, which can lead to rupturing at its periphery from the tensile stresses at the periphery that can build up during lengthwise compression.

In some embodiments, the CCF member may be formed so as to have a spring rate and/or damping characteristics that vary depending on the amount of compression. These characteristics can be provided via the use and combination of different CCF foam densities of material (changing the recipe) along its length, and/or by the use of different contours molded into the OD or ID of a given spring shape.

Use of a CCF member may be advantageous in applications where it will be submerged in oil or grease, since in at least some embodiments, the CCF member can incur contact with oil or grease without absorption or degradation, due to the closed-cell structure of the material of the CCF member.

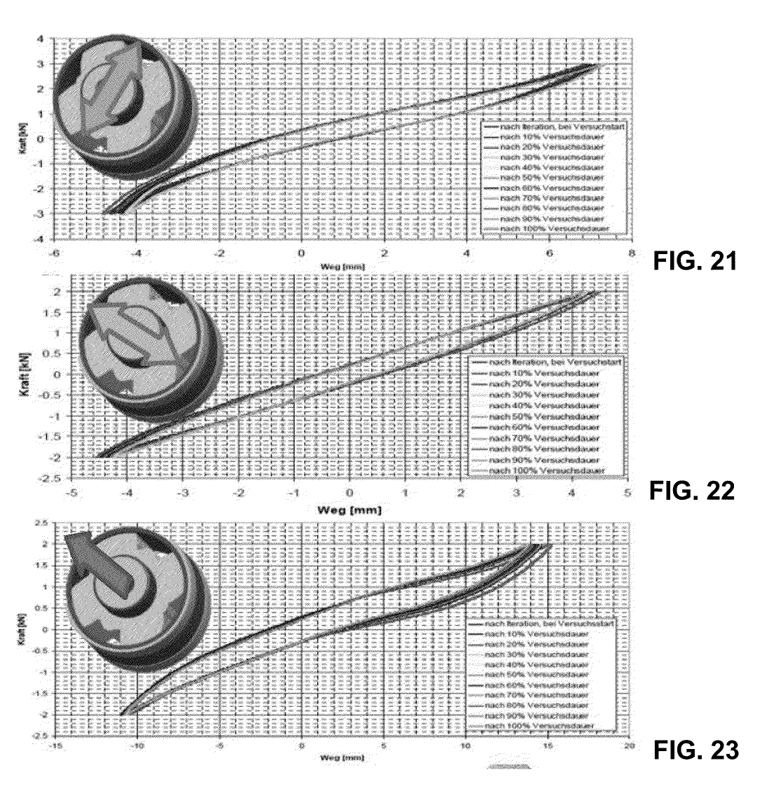

FIGS. 21-23 show several force/displacement curves for different types of flexure of a CCF member.

A possible tensioner configuration using a CCF member as described herein, may include a highly-controlled spring elasticity and damping output within a compact rotary/compression spring damper mechanism. This could be accomplished by using one or more thin washers manufactured from the CCF closed-cell foam material, whereby two or more counter rotating steel washers, each with a matching ramped contour, would be configured to produce a controlled linear displacement when rotated against one another through an angular displacement or oscillation.

Those skilled in the art will appreciate that a variety of modifications may be made to the embodiments described herein without departing from the fair meaning of the accompanying claims.

1. A tensioner for an endless drive member, comprising:
a base that is mountable to a stationary structure, wherein the base defines a tensioner arm pivot axis;
a tensioner arm that is mounted to the base and is pivotable about the tensioner arm pivot axis;
a pulley rotatably connected to the tensioner arm for rotation about a pulley axis that is spaced from the tensioner arm pivot axis; and
a tensioner arm biasing member positioned to urge the tensioner arm in a free arm direction, wherein the tensioner arm biasing member includes a closed-cell foam member.

2. A tensioner as claimed in claim 1, further comprising a tensioner arm biasing member support having a first end member that is pivotally connected to a stationary structure and a second end member that is pivotally connected to the tensioner arm, wherein the closed-cell foam member is positioned to urge the first and second end members away from each other.

4. A tensioner as claimed in claim 1, wherein the closed-cell foam member has a length and a cross-sectional area that varies along the length.

5. A tensioner as claimed in claim 1, wherein the closed-cell foam member has an outer surface that is corrugated.

6. A tensioner as claimed in claim 1, wherein tensioner arm biasing member further includes a compression spring positioned to operate in series with the closed-cell foam member.

7. A tensioner as claimed in claim 1, wherein tensioner arm biasing member further includes a compression spring positioned to operate in parallel with the closed-cell foam member.

8. A tensioner as claimed in claim 2, further comprising an installation pin that is removably connected to the tensioner arm biasing member and arranged to lock the first and second members relative to one another so as to lock the tensioner arm in a selected arm position.

9. A tensioner as claimed in claim 1, wherein the closed-cell foam member has a longitudinal axis and the closed-cell foam member is provided with an internal aperture coaxially aligned to the longitudinal axis, the internal aperture extending along at least a portion thereof.

10. A tensioner as claimed in claim 9, wherein the internal aperture is conical in shape.

11. A tensioner as claimed in claim, wherein the closed-cell foam member exerts a damping force during compression.

12. A tensioner as claimed in claim 1, wherein the tensioner arm is positioned in rotatable and surrounding relationship relative to the base and has at least one arm projection, and wherein the base has at least one stationary base projection, and wherein the closed-cell foam member is positioned angularly between the arm and base projections.

13. A tensioner as claimed in claim 12, wherein the closed-cell foam member provides at least one lobe for engagement between the arm and base projections.

14. A tensioner as claimed in claim 12, wherein the closed-cell foam member is provided with a first lobe and a second lobe, and wherein the first lobe is positioned for engagement between a first arm projection and the stationary base projection, and wherein the second lobe is positioned for engagement between a second arm projection and the stationary base projection.

15. A tensioner as claimed in claim 12, further comprising at least one additional stationary engagement surface on the base for cooperation with the arm projection to engage a secondary closed-cell foam member.

16. A tensioner as claimed in claim 12, further comprising a second stationary base projection on the base, and wherein the closed-cell foam member is provided with four lobes positioned angularly between the opposing base projections and the opposing arm projections.

17. A tensioner for an endless drive member, comprising:
a base that is mountable to a stationary structure;
a tensioning guide that is positioned to engage the endless drive member; and
a tensioner biasing member positioned to urge the tensioning guide into the endless drive member,
wherein the tensioner biasing member includes a closed-cell foam member.

18. A tensioner for an endless drive member, comprising:
a base that is mountable to a stationary structure, wherein the base defines a tensioner arm pivot axis;
a tensioner arm that is mounted to the base and is pivotable about the tensioner arm pivot axis;
a pulley rotatably connected to the tensioner arm for rotation about a pulley axis that is spaced from the tensioner arm pivot axis; and
a closed-cell foam member that urges the tensioner arm in a free arm direction and exerts a damping force during compression.

19. A tensioner as claimed in claim 18, wherein the closed-cell foam member is compressible by the tensioner arm by at least 50 percent.

20. A tensioner as claimed in claim 18, wherein the closed-cell foam member is shaped to expand laterally by less than 40 percent during use between a free arm position and a load stop position.
